(19) United States
(12) Patent Application Publication
(10) Pub. No.: US 2009/0123099 A1
(43) Pub. Date: May 14, 2009

(54) Bearing Assembly With a Seal-Forming Bore Clip

(75) Inventors: Ronald P. Dickerhoff, Canton, OH (US); David G. Toth, North Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: The Timken Company, Canton, OH (US)

(21) Appl. No.: 11/817,103

(22) PCT Filed: Mar. 1, 2006
(86) PCT No.: PCT/US06/07220

§ 371 Date: Aug. 24, 2007

Related U.S. Application Data
(60) Provisional application No. 60/657,885, filed on Mar. 2, 2005.

(51) Int. Cl. B61F 15/12; B23P 11/00

(52) U.S. Cl. 384/459; 29/428

(57) ABSTRACT

A bearing assembly (A1C) for installation over the journal (6,100) at the end of a railcar axle (4) has a backing ring (16,104) that seats against a fillet (10) at the end of the journal, an antifriction bearing (B1D) that fits around the journal, and an end cap (18,106) that extends over the end of the journal to retain the bearing and backing ring around the journal. In one form, the bearing (B) has two cones (32) that fit over the journal with an interference fit, with the inboard cone abutting the backing ring (16). A bore clip (22) holds the backing ring and inboard cone together in alignment before installation on the journal. In another form, a wear ring (108) is interposed between the backing ring (104) and the inner race (102) of the bearing (D), and the bore clip (22) extends between the backing ring and the wear ring. Once the backing ring and bearing are installed over the journal, the bore clip establishes a fluid barrier at the base of the fillet to prevent water from reaching and corrosion form developing at this critical area where flexure is greatest and also establishes fluid barriers with inside surfaces of the backing ring and inner race or wear ring.

### CROSS-REFERENCE TO RELATED APPLICATIONS

This application derives priority from U.S. provisional application 60/657,885 filed 2 Mar. 2005.

### TECHNICAL FIELD

This invention relates in general to the bearing assemblies for installation on journals that end at fillets, and more particularly to a backing ring together and a bore clip coupled with the backing ring.

### BACKGROUND ART

The typical railcar rides on several wheel sets, each having wheels and an axle to which the wheels are fitted. The axles project beyond the wheels where they are provided with journals, and the journals rotate on antifriction bearings received in side frames of railcar trucks. This transfers the suspended weight of the rail car to the wheel sets.

In recent years railroads have turned to shorter journals to reduce flexure in the journals. This enables the wheel sets and the railcar bodies that they support to carry greater loads. But the shorter journals require modified bearings, backing rings and end caps, which in turn present problems of their own. One problem resides in unifying the bearing assemblies for the shorter journals so that they can be handled easily for installation over the journals with automated assembly equipment. Whereas the typical bearing assembly for a longer journal has a wear ring received in a seal at the inboard end of the bearing and also captured in the backing ring to thus hold the backing ring in alignment with the bearing, a bearing assembly for a shorter journal has no wear ring. Instead, its backing ring abuts the end of the inboard cone (inner race) for the bearing. Some manufacturers use a so-called “bore clip” between the inboard cone and the backing ring to hold the backing ring against the cone. Others have resorted to a double-sided adhesive-backed ring between the end face of the inboard cone and the backing ring to hold the backing ring against the cone. But the adhesive ring does not provide a positive connection, and during rough handling, such as in automated assembly equipment, the backing ring may move out of alignment with the inboard cone. The misalignment disrupts installation of the backing ring and bearing on a journal, particularly with robotic assembly equipment.

Just as significant, the abutting faces of the backing ring and inboard cone may separate when the bearing is in use, and this provides a gap allowing for the ingress of water. More water may seep into this area from the opposite end of the backing ring and along the fillet that it surrounds. Irrespective of the source of the water it corrodes the journal at the base of the fillet, the very same area where the journal experiences its greatest flexure. The corrosion together with fretting, caused by the backing ring rubbing against the fillet weakens the journal at the base of the fillet and can lead to an axle break. To be sure, fitted backing rings exist and that type of ring has a lip that fits tightly over the dust guard diameter at the large end of the fillet and stabilizes the backing ring to a measure so that movement between the backing ring and fillet is reduced. The tightly fitted lip also retards the migration of water underneath the backing ring and along the fillet. But fitted backing rings introduce additional expense because of the tolerances that must be held in the machining of the lip and the dust guard diameter. And furthermore, not all backing rings are of the fitted variety.

Even the longer journals fitted with more traditional bearing assemblies are subjected to corrosion caused by the migration of water in their backing rings.

### SUMMARY OF THE INVENTION

The present invention resides in a bearing assembly including a backing ring and a bearing having an inner race, with the backing ring and inner race being united by a bore clip that is flexible enough to establish a fluid barrier against a fillet at the end of a journal. The invention also resides in an annular element located between the backing ring and the fillet to establish a fluid barrier. The invention further resides in a process for installing the bearing assembly over a journal, with the inner race of the bearing and the backing ring being united during installation by the bore clip that further establishes a fluid barrier along the fillet.

### DESCRIPTION OF DRAWINGS

FIG. 1 is a longitudinal sectional view of a bearing assembly fitted to a railcar journal and including a bearing, with a backing ring and end cap, with the inboard cone of the bearing and the backing ring being united with a bore clip that establishes a fluid barrier along the journal, all in accordance with the present invention;

FIG. 2 is an enlarged sectional view of the bore clip and the nearby regions of the inboard cone, backing ring, and journal;

FIG. 3 is an enlarged sectional view of a modified bore clip and the nearby regions of the inboard cone, backing ring, and journal.

FIG. 4 is a longitudinal sectional view of another bearing assembly that includes a wear ring interposed between the inner race of the bearing and the backing ring, with the bore clip extending between the backing ring and the wear ring; and

FIG. 5 is an enlarged sectional view of the bore clip in FIG. 4 and the nearby regions of the backing ring and wear ring.

### BEST MODE FOR CARRYING OUT THE INVENTION

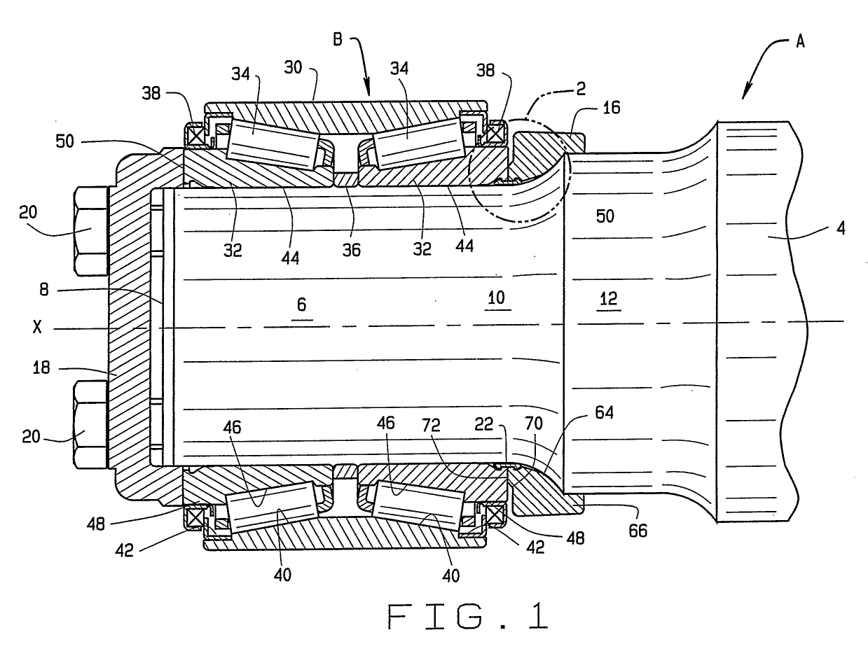

Referring now to the drawings (FIG. 1) a compact bearing assembly A fits over one end of an axle 4, which together with wheels forms one of several wheel sets for a railcar. The bearing assembly A, along with another at the other end of the axle 4, enables the axle 4 to rotate about an axis X, which is the centerline of the axle 4, as the wheels roll over the rails of a railroad track. Indeed, the bearing assembly A transfers a portion of the suspended weight of the railcar to the wheel set. Actually, the weight is transferred through an antifriction bearing B that forms part of the bearing assembly A. It fits over a journal 6 at the end of the axle 4—a journal that is somewhat shorter than traditional journals in order to reduce flexure under the weight transferred through the bearing B.

The journal 6 at outboard end has an end face 8 that is perpendicular to the axis X. At its inboard end the journal 6 has a fillet 10 that leads to a larger dust guard diameter 12 of cylindrical configuration, and the dust guard diameter 12 leads to a wheel seat to which one of the wheels for the wheel set is fitted. Between the end face 8 and the fillet 10 the journal 6 possesses a cylindrical configuration. The fillet 10 flares outwardly from the cylindrical portion of the journal 6 and presents a concave surface away from the axis X.

In addition to the bearing B, which fits over the cylindrical portion of the journal 6, the bearing assembly A includes a backing ring 16 that encircles and seats against the fillet 10, an end cap 18 that fits over the end face 8, and cap screws 20 that hold the entire bearing assembly A on the journal 6. Finally, the bearing assembly A has a bore clip 22 that attaches the backing ring 16 to the bearing B for handling prior to installation on the journal 6 and further serves to establish a fluid barrier after installation.

The bearing B includes (FIG. 1) an outer race in the form of a cup 30, an inner race in the form of two cones 32 located within the cup 16, and rolling elements in the form of tapered rollers 34 organized in two rows between the cup 30 and cones 32. In addition, the bearing B includes a spacer 36 located between the two cones 32 to maintain a prescribed spacing between the cones 32. The ends of the bearing B are closed by seals 38 located between the ends of the cup 30 and the cones 32.

The cup 30 fits into an adapter located in the truck of the railcar. It has two raceways 40 which taper downwardly toward each other. At their large ends the raceways 40 open into counterbores 42 which in turn open out of the ends of the cup 30.

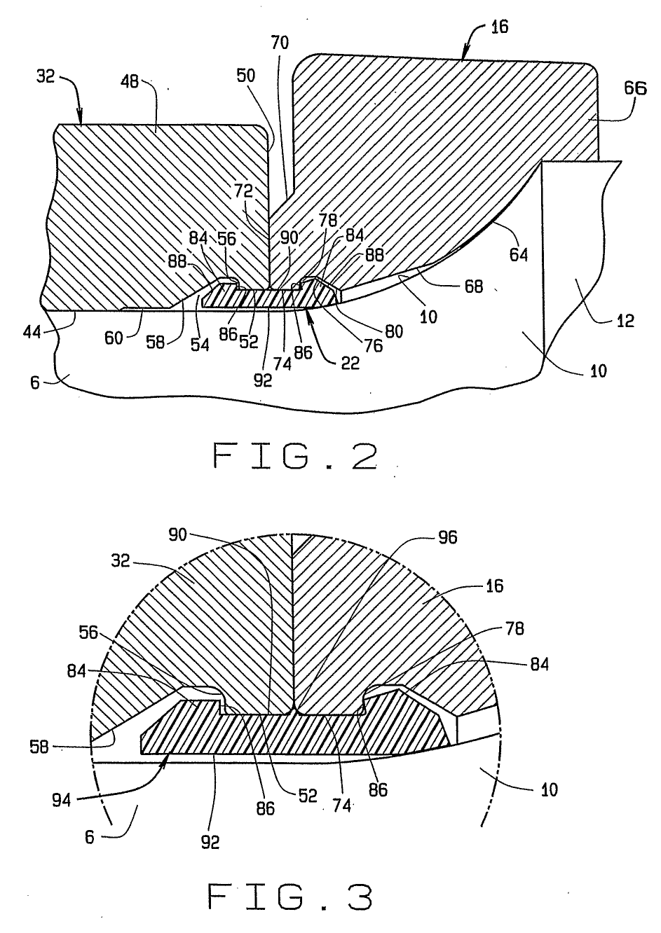

The cones 32 fit over the journal 6 with interference fits and with the spacer 36 located between them. Each cone 32 has a bore 44 defined mostly by a cylindrical surface that is presented inwardly toward the axis X. The diameter of the bore 44 is slightly less than the diameter of the cylindrical region of the journal 6. As a consequence, the cones 32 must be forced over the journal 6, and when so installed, interference fits exist between the cones 32 and the journal 6. Each cone 32 also has a tapered raceway 46 that is presented outwardly away from the axis X and toward one of the raceways 42 on the cup 30. Each cone 32 also has a thrust rib 48 at the large end of its raceway 46, and it leads out to a back face 50 that is squared off with respect to the axis X. Finally, at least the inboard cone 32, within its thrust rib 48 and along its bore 44, has (FIG. 2) a deep undercut 52 that opens into the bore 44 and out of the back face 50 at a small radius. The undercut 52 leads to a groove 54 that opens inwardly toward the axis X and of course into the bore 44. The groove 54 has a radial face 56 at the undercut 52 and a tapered face 58 opposite the radial face 56. The tapered face 58 tapers downwardly to a shallow undercut 60. The deep undercut 52, the groove 54, and the shallow undercut 60 all lie within the thrust rib 48, so they do not extend beneath the raceway 46. Moreover, the two undercuts 52 and 60 and the groove 54 present surfaces of circular configuration toward the axis X, which surfaces have their centers at the axis X and are of a diameter greater than the cylindrical region of the journal 6. Preferably the outboard cone 32 also has undercuts 52 and 60 and an intervening groove 54 to enable the bearing B to be reversed in position on the journal 6.

The two cones 32 lie within the cup 30, with the raceway 46 on the inboard cone 32 being presented toward and tapering in the same direction as the inboard raceway 40 of the cup 30 and with the raceway 46 of the outboard cone 32 being presented toward and tapering in the same direction as the outboard raceway 40 of the cup 30. The spacer 36 also lies within the cup 30 between the two cones 32.

The tapered rollers 34 are organized in two rows, one around each cone 32. Here their side face contact the tapered raceways 40 and 46 of the cup 30 and cones 32, respectively. Their large end faces bear against the thrust ribs 48 of the cones 32, so the thrust ribs 48 prevent the rollers 34 from moving up the raceways 40 and 46 and being expelled from the annular space between cup 30 and cones 32. The rollers 34 of each row are on apex, meaning that the conical envelopes in which their tapered side face lie and the envelopes for the two raceways 40 and 46 that they contact have their apices at a common point along the axis X.

The seals 38 fit into the counterbores 42 at the ends of the cup 30 and around the thrust ribs 48 on the cones 32. As such, they establish dynamic fluid barriers between the cup 30 and the cones 32 at the ends of the bearing B. In addition, they are configured to prevent the cones 32 from withdrawing from the cup 30, and in that sense they unitize the bearing B.

The bearing B fits over the journal 6 with its cones 32 fitted snugly to the cylindrical region of the journal 6, but not the spacer 36. The backing ring 16 likewise fits over the journal 6, where it lies between the fillet 10 and the inboard cone 32. It serves as a backing for the bearing B. To this end, the backing ring 16 has an arcuate inner surface 64 which conforms in size and contour to the fillet 10, that is to say, to the region of the fillet 10 that leads up to the dust guard diameter 12. Indeed, the backing ring 16 along its arcuate surface 64 seats against the fillet 10. At the large end of its arcuate surface 64 the backing ring 16 may have an annular lip 66 that projects over the dust guard diameter 12. Preferably an interference fit exists between the lip 66 and the dust guard diameter 12. At its small end the arcuate surface 64 leads into a conical surface 68 that is spaced outwardly from the fillet 10. Beyond the conical surface 68 the backing ring 16 has an annular projection 70 that terminates at an end face 72 that is squared off with respect to the axis X. The backing ring 16 abuts the inboard cone 32. Indeed, the inboard cone 32 and the backing ring 16 are in face-to-face contact along their respective faces 50 and 72. Like the inboard cone 32, the backing ring 16 has (FIG. 2) an undercut 74 that at one end opens out of the end face 72 at a small radius and otherwise leads into a groove 76. The undercut 74, which forms the end of a bore in the backing ring 16, possesses the same diameter as the undercut 52 on the inboard cone 32 and aligns with it. The lengths of the two undercuts 52 and 60 are about the same, and that distance is generally equivalent to the length of the projection 70. The groove 76, which opens toward the axis X, has a radial face 78 at the end of the undercut 74 and a tapered face 80 that leads out to the small end of the conical surface 68. Basically, the groove 76 possesses the same cross-sectional configuration as the groove 54 in the inboard cone 32.

When the backing ring 16 along its arcuate surface 64 seats against the fillet 10 of the journal 6, the undercut 74 in the backing ring 16 encircles the cylindrical portion of the journal 6 immediately before the fillet 10. The groove 76, on the other hand, opens toward the fillet 10 where the fillet 10 begins to flare away from the cylindrical region. The radial surface 78 lies essentially at the juncture of the cylindrical region and the fillet 10 on the journal 6.

The bearing B and backing ring 16 do not occupy the full journal 6. A short segment of the journal 6 projects beyond the back face 50 of the outboard cone 32. The end cap 18 surrounds (FIG. 1) this segment of the journal 16 and further extends across the end face 8 of the journal 6, yet is spaced slightly from the end face 8. The cap screws 20 pass through the end cap 18 parallel to the axis X and thread into the journal 6. When turned down, they cause the two cones 32 and the spacer 36 to become clamped tightly between the backing ring 16 and the end cap 18. And, of course, the taper of the raceways 40 and 46 and of the rollers 34 prevents the cup 30 from displacing axially with respect to journal 6.

The bore clip 22 unites (FIG. 2) the backing ring 16 and the inboard cone 32 prior to and during the installation of the bearing B and backing ring 16 on the journal 6. It further forms an annular sealing element that establishes a static fluid barrier between the inboard cone 32 and the backing ring 16 and another static fluid barrier between the backing ring 16 and the fillet 10. The fluid barriers isolate the critical area of the journal 16 at the juncture of its cylindrical region and fillet 10 from moisture which might otherwise corrode the journal 6 at that critical region. The bore clip 22 fits into the two grooves 54 and 76 in the inboard cone 32 and backing ring 16, respectively, and spans the region of contact between the two at their abutting faces 50 and 72. It possesses a ring-like or annular configuration and is preferably molded from a polymer that is reasonably hard, yet flexible enough to conform to a harder steel surface and effect a fluid tight barrier with such a surface. EL-72 polyurethane, which is sold by System Seals, Inc., has proven to be particularly well-suited for the bore clip 22. Irrespective of the substance from which it is formed, the bore clip 22 is softer and more flexible than the steel of the journal 6 and is continuous circumferentially in the sense that is lacks an axial gap through which water could flow through it.

The bore clip 22 at each of its ends has an annular rib 84 which is directed radially outwardly, yet is slightly smaller than either the groove 54 of the inboard cone 32 or the groove 76 in the backing ring 16. Each rib 84 has a radially directed inside face 86 and a beveled outside face 88. The spacing between the inside faces 86 equals or is slightly more than the spacing between the radial faces 56 and 78 of the grooves 54 and 76 in the inboard cone 32 and backing ring 16, respectively.

Extending between the inside faces 86 of the two ribs 84 is a cylindrical outer surface 90, the diameter of which slightly exceeds the diameter of the undercuts 52 and 74 on the inboard cone 32 and backing ring 16. The bore clip 22 also has a cylindrical inner surface 92 which extends the full length of the clip 84 from one outside surface 88 to the other. The diameter of the inner surface 92 exceeds the diameter of the cylindrical portion of the journal 6 by at least 0.005 in. Even so, the diameter is not so great that the inner surface 92 clears the fillet 10. Indeed, the bore clip 22 along its inner surface 92 actually contacts and is deflected outwardly by the fillet 10 immediately beyond where the fillet 10 emerges from the cylindrical region of the journal 6.

Prior to installation of the bearing B and backing ring 16 on the journal 6, the seals 38 retain the two cones 32 in the double cup 30 and along with the rollers 34 keep the bores 44 of the two cones 32 in aligned. The bore clip 22 attaches the backing ring 16 to the inboard cone 32 with the arcuate seating surface 64 aligned with the cone bores 44. To this end, the bore clip 22 is initially installed in the inboard cone 32 by aligning one of its beveled faces 88 with the undercut 52 of the cone 32 and forcing the bore clip 22 into the end of the cone 32. Under the force applied the beveled face 88 that is against the cone 32 cams its rib 84 inwardly, causing the rib 84 to contract and pass through the undercut 52. Once beyond the undercut 52, the rib 84 snaps outwardly into the groove 54, with its inside face 86 lying along the radial face 56 of the groove 40. After the bore clip 22 is fitted to the inboard cone 32, the undercut 74 on the backing ring 16 is aligned with the beveled face 88 at the other end of the clip 22—the end protruding from the inboard cone 32. Thereupon, the backing ring 16 is forced toward the cone 32. The end of the undercut 74 in the backing ring 16 advances over the beveled face 88 on the exposed rib 84 and cams that rib 84 inwardly. The rib 84 contracts enough to pass through the undercut 74, beyond which it expands outwardly into the groove 76 in the backing ring 16. With the bore clip 22 so disposed, its inside faces 86 lie along the radial faces 56 and 78 of the grooves 54 and 76, and prevent the inboard cone 32 and backing ring 16 from separating. The outer surface 90, which extends between the inside faces 86 on the clip 22, lies along and snugly against the surfaces of the undercuts 52 and 74 in the cone 32 and backing ring 16 and maintains axial alignment between the cone 32 and the backing ring 16. The outer surface 90 further establishes a static fluid barrier with both the inboard cone 32 and the backing ring 16—a barrier that prevents water that may seep between the abutting faces 50 and 72 on the cone 32 and backing ring 16 from migrating any farther.

The bearing B and the backing ring 16 joined together with the bore clip 22 are installed over the journal 6. To this end, the journal 6, including its fillet 10, is coated with a heavy press-fit lubricant. Thereupon, the aligned arcuate surface 64 of the backing ring 16 and the bores 44 of the cones 32 are aligned with the journal 6, and with the backing ring 16 leading, the backing ring 16 and bearing B are advanced over the journal 6. The backing ring 16 passes easily over the end of the journal 6 as does the bore clip 22, all while leaving the coating of press-fit lubricant intact. After all, both are somewhat larger than the cylindrical portion of the journal 6. However, after the shallow undercut 60 in the inboard cone 32 passes over the end of the journal 6, the journal 6 encounters the smaller bore 44 of the inboard cone 32. Thereupon, a force is applied to the back face of the outboard cone 32, and that force drives the two cones 32, with the spacer 36 between them, over the journal 6 until the arcuate surface 64 in the backing ring 16 seats against the fillet 10 of the journal 6. During the final increment of advance the leading end of the bore clip 22, along its cylindrical inner surface 92 contacts the fillet 10 immediately beyond the location where the fillet 10 flares outwardly. The fillet 10 deflects the end of the inside surface 92 and the surrounding rib 84 outwardly. Being in contact with the fillet 10, the clip 22 along it's inside surface 92 establishes a static fluid barrier along the fillet 10. Enough clearance exists between the rib 84 and the tapered surface 80 of the groove 76 in the backing ring 16 to accommodate the outward deflection of the rib 84, but the rib 84 at its inside face 86 is urged against the radial face 78 of the groove 76, establishing another static fluid barrier.

A modified bore clip 94 (FIG. 3) resembles the bore clip 22 in most respects. However, along its outer cylindrical surface 90, midway between the two inside faces 86, it has another annular rib 96 that is smaller than the ribs 84 at each end and possesses a convex configuration. The rib 96 is configured to fit into the annular cavity formed by the radius where the back face 50 and undercut 52 of the inboard cone 32 merge and the radius where the end face 72 and undercut 74 of the backing ring 16 merge. The rib 96 establishes a static barrier at the two radii, and it prevents water that may seep along the back face 50 and end face 72 from migrating any farther. This provides an extra measure of protection should there be an ineffective barrier along the radial face 78 of the groove 76 in the backing ring 16, or along the undercut 52 in the inboard cone 32 and the undercut 74 in the backing ring 16, or perhaps caused by fretting along the back face 50 of the inboard cone 32 and the contacting and face 72 of the backing ring 16.

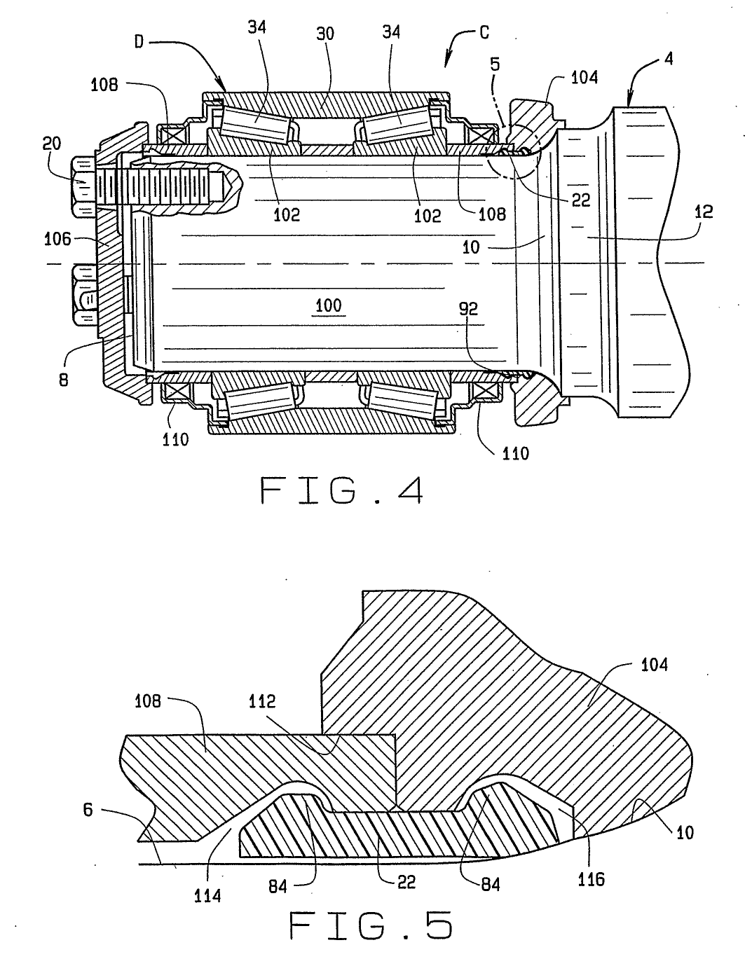

The bore clip 22 also has utility in a traditional bearing assembly C (FIG. 4) configured to fit over a journal 100 that is longer than the journal 6, but otherwise the same. Like the journal 6, the journal 100 has an end face 8 and at its opposite end a fillet 10 that leads out to a dust guard diameter 12. The bearing assembly C includes a bearing D that is similar to the bearing B, but differs in that it has shorter cones 102 that do not have the undercut 52. In addition, the bearing assembly C has a backing ring 104 that fits around and seats against the fillet 10, an end cap 106 that fits over the end face 8, and cap screws 20 that thread into the journal 100 and hold the entire bearing assembly C on the journal 100. Also, in contrast to the bearing assembly A, the bearing assembly C has wear rings 108 that bear against the back faces 50 of the two cones 102. Actually, the inboard wear ring 108 is clamped between the inboard cone 102 and the backing ring 104, whereas the outboard wear ring 108 is clamped between the outboard cone 102 and the end cap 106. Also, the bearing assembly C has seals 110 that fit into the ends of the cup 30 and around the wearing rings 108 to establish dynamic fluid barriers between the cup 30 and wear rings 108. And of course, the bearing assembly C has the bore clip 22.

To accommodate the inboard wear ring 108, the backing ring 104 has a machined recess 112 (FIG. 5) that receives end of the wear ring 104 with an interference fit. That end of the wear rings 108 is relieved internally so that some of it lies away from the cylindrical surface of the journal 100 and also from the surface of the fillet 10 where the fillet 10 begins to flare outwardly. Here the wear ring 108 is provided with an undercut 114 that corresponds to the undercut 52 in the inboard cone 32 of the bearing B. Moreover, the backing ring 104 has an undercut 116 that corresponds to the undercut 74 in the backing ring 16 of the bearing assembly A. The bore clip 22 fits into the two undercuts 114 and 116 and bears singly against the inside surface of the inboard wear ring 108 and the inside face of the backing ring 104. Here it establishes fluid barriers that prevent moisture from reaching the journal 100, even if the fit between the inboard wear ring 108 and the backing ring 106 becomes loose as a consequence of flexure in the journal 100 and the fretting that flexure can cause at the recess 112.

Apart from that, during the installation of the bearing assembly C over the journal 100, at the final increment of advance when the backing ring 104 seats against the fillet 10, the inboard end of the bore clip 22 becomes compressed between the backing ring 104 and the fillet 10. This creates another fluid barrier—a barrier that prevents any moisture that migrates down along the fillet 10 from going any farther.

The modified bore clip 94 may be substituted for the bore clip 22 in the bearing assembly C.

The bearing assemblies A unitized with either the bore clip 22 or the bore lip 94 may be used on journals other than those of railcar axles, for example, the journals on the ends of mill rolls. Moreover, the bearings B or D need not be double row tapered roller bearings, but may take other forms as well, such as angular contact ball bearings, spherical roller bearings or cylindrical roller bearings.

1-21. (canceled)

22. In combination with a journal that has a cylindrical surface that defines an axis and a fillet that flares outwardly from the cylindrical surface, the improvement comprising:
a backing ring located around and seated against the fillet, the backing ring having a groove that opens inwardly toward the fillet;
an annular element in the form of a bearing race or a wear ring abutting the backing ring, the annular element having a groove that opens inwardly toward the cylindrical surface of the journal;
a bore clip that spans the space between the grooves in the backing ring and the annular element and has ribs that project into the grooves in the backing ring and annular element, the bore clip being formed from a flexible material that is capable of deforming to effect a fluid barrier, the end of the bore clip that lies within the backing ring being deformed against and contacting the fillet to effect a fluid barrier with the fillet at a diameter greater than the diameter of the cylindrical surface of the journal.

23. The combination according to claim 22 wherein the bore clip has a surface that is presented outwardly away from the axis and effects a fluid barrier with the backing ring.

24. The combination according to claim 23 wherein the surface of the bore clip that effects a fluid barrier with a backing ring also effects a fluid barrier with the annular element.

25. The combination according to claim 22 wherein the bore clip has an inner surface that is presented toward the axis but is spaced from the cylindrical surface of the journal, so that the bore clip does not contact the cylindrical surface of the journal.

26. The combination according to claim 22 wherein the annular element takes the form of the inner race for a bearing.

27. The combination according to claim 26 wherein the inner race has a back face and the backing ring has an end face; and wherein the inner race and backing ring contact each other face to face along the back face of the inner race and the end face of the backing ring.

28. The combination according to claim 26 and further comprising an outer bearing race located around the inner race and rolling elements located between and contacting the inner and outer races.

29. The combination according to claim 22 wherein the annular element takes the form of the wear ring that a seal contacts to establish a dynamic fluid barrier.

30. The combination according to claim 22 wherein the bore clip encircles the location where the fillet emerges and flares outwardly from the cylindrical surface of the journal.

31. The combination according to claim 30 wherein the bore clip has a cylindrical inner surface, the diameter of which exceeds the diameter of the cylindrical surface of the journal, so that the bore clip does not interfere with the installation of the backing ring and annular element over the journal.

32. A bearing assembly for facilitating rotation about an axis, said bearing assembly comprising:
an annular element in the form of an inner bearing race or a seal wear ring that abuts an inner bearing race, the annular element having a bore that opens out of its ends and a groove that opens inwardly into the bore;
a backing ring having an end face that abuts an end of the annular element and an inner surface that flares outwardly away from the annular element and is configured to seat against a fillet on a journal, the backing ring also having a groove that opens inwardly into its interior; and
a bore clip located within the annular element and the backing ring and spanning the space between the grooves in each, the bore clip having ribs that project into the grooves of the annular element and bore clip and being formed from a flexible material that effects a fluid barrier with the annular element and the backing ring, the bore clip further being capable of deflecting within the backing ring to effect a fluid barrier with a fillet on a journal.

33. A bearing assembly according to claim 32 wherein the annular element takes the form of the inner race.

34. A bearing assembly according to claim 32 wherein the annular element takes the form of the wear ring.

35. A bearing assembly according to claim 32 wherein the bore clip has a generally cylindrical exterior surface and effects fluid barriers with the annular element and backing ring along the cylindrical exterior surface.

36. A bearing assembly according to claim 32 wherein the bore clip effects fluid barriers with the annular element and the backing ring between the grooves in each.

37. A bearing according to claim 32 wherein the ribs have beveled end faces.

38. A process of installing a bearing assembly, including a backing ring and an annular element, in the form of an inner race or a wear ring, on a journal having a cylindrical surface and a fillet at the end of the cylindrical surface where it flares outwardly; said process comprising:
uniting the backing ring and the annular element with a bore clip that fits into the backing ring and the inner race and is large enough to fit easily over the cylindrical surface of the journal but not the fillet;
advancing the backing ring and the annular element over the cylindrical surface of the journal, with the backing ring and the annular element being united by the bore clip; and
deflecting the leading end of the bore clip against the fillet of the journal to establish a fluid barrier along the fillet.
